(19) United States
(12) Patent Application Publication
(10) Pub. No.: US 2015/0220623 A1
(43) Pub. Date: Aug. 6, 2015

(54) SYSTEM AND METHOD FOR PATHWAY CONSTRUCTION

(71) Applicant: KOREA INSTITUTE OF SCIENCE AND TECHNOLOGY INFORMATION, Daejeon (KR)

(72) Inventors: Chang Hoo Jeong, Daejeon (KR); Sung Pil Choi, Daejeon (KR); Hong Woo Chun, Daejeon (KR); Mi Nyeong Hwang, Daejeon (KR); Sung Jae Jung, Incheon (KR); Han Min Jung, Daejeon (KR)

(21) Appl. No.: 14/419,336

(22) PCT Filed: Aug. 1, 2013
(86) PCT No.: PCT/KR2013/006941

§ 371 Date: Apr. 6, 2015

(30) Foreign Application Priority Data
Aug. 3, 2012 (KR) 10-2012-0085254

(51) Int. Cl. G06F 17/30

(52) U.S. Cl. CPC G06F 17/30696; G06F 17/30864

(57) ABSTRACT

The present invention relates to a system and method for pathway construction, including an advance information database for storing an entity name of protein, diseases, compounds, symptoms, enzymes, medicines, diseases, place and/or pathway; an entity recognition unit for recognizing entities from an input document using the advance information database; a relation recognition unit for extracting context between the recognized entities based on the pre-stored context pattern information, and recognizing a relation between the entities by normalizing the extracted context; a relation event generating unit for performing a web search for the recognized entities to collect a document including the entities and information on the points in cells of the entities, and generating a relation event based on the collected information; and a pathway generating unit for displaying relevant entities at the relevant points in the cells based on the recognized relation event to generate a pathway.

### TECHNICAL FIELD

The present invention relates to a system and method for constructing a pathway, and more specifically, to a system and method for constructing a pathway, which recognizes entities from an input document, generates a relation event of the entities by performing a web search targeting the recognized entities, and creates the pathway by displaying relevant entities at relevant locations in a cell based on the relation event.

### BACKGROUND ART

A pathway in the field of biology is a data structure expressing various technical terminologies appearing in a technical document and semantic correlations among them in the form of a network, and it may be, from the viewpoint of biotechnology, regarded as biological deep knowledge describing in detail the dynamics, interactions or the like among biological elements such as proteins, genes, cells and the like.

In the field of biology, a pathway database of a good quality may function as a biology-based knowledge resource which can effectively support core research activities in the biomedical field such as (1) understanding a life activity mechanism of various living creatures, (2) identifying actual causes of occurrence, progress, spontaneous regression and treatment of a disease, and (3) a work of searching for a novel material, such as chemical synthesis, extraction of natural products or the like, in developing a new medicine having a new mechanism.

Despite the practical advantages from the viewpoint of knowledge service, together with efficient research and development in the biotechnology field, there are a lot of problems and limits currently from the aspect of constructing, associating and utilizing the pathway database.

That is, since an existing pathway database is manually constructed, an enormous amount of construction cost is needed due to the manual work, and the database cannot be promptly expanded and updated to keep pace with development of techniques.

Furthermore, from the aspect of pathway database association, efficiency of cost is lowered since the same contents are redundantly constructed, and it is difficult to interconnect different organisms and compounds.

Furthermore, there is a limit in that a knowledge processing technique based on an existing pathway database does not exist since an in-depth scientific knowledge service utilizing a pathway does not exist.

### DISCLOSURE

### Technical Problem

Therefore, the present invention has been made in view of the above problems, and it is an object of the present invention to provide a system and method for constructing a pathway, which recognizes terminologies expressing a protein, a disease, an enzyme, a medicine, a compound and a symptom from a bio-field document and automatically constructs the pathway based on the terminologies.

Another object of the present invention is to provide a system and method for constructing a pathway, which can minimize manual works needed for constructing the pathway by providing bio-field documents for manual verification of the constructed pathway.

### Technical Solution

To accomplish the above objects, according to one aspect of the present invention, there is provided a pathway construction system including: an dictionary information database for storing entity names of at least one of a protein, a disease, a compound, a symptom, an enzyme, a medicine, a location and a pathway; an entity recognition unit for recognizing entities from an input document using the dictionary information database; a relation recognition unit for extracting a context between the recognized entities based on previously stored context pattern information and recognizing a relation between the entities in a method of normalizing the extracted context; a relation event generation unit for collecting documents in which the recognized entities appear and information about protein subcellular localizations by performing a web search targeting the entities, and generating a relation event based on the collected information; and a pathway creation unit for creating the pathway by displaying relevant entities at relevant locations in the cell based on the recognized relation event.

The pathway construction system may further include a visualization unit for visualizing the pathway created by the pathway construction unit.

When a specific entity is selected from the visualized pathway, the visualization unit may acquire source information of the specific entity and display the source information in a predetermined area of the pathway, and when a line connecting two entities is selected from the pathway, the visualization unit may display sentences or paragraphs of a document which can explain a relation between the two entities.

In addition, the pathway construction system may further include a verification unit for receiving editing information on the pathway visualized by the visualization unit from a user and storing the editing information in a pathway database.

In the case of a paragraph or a sentence in which two or more entities are recognized, the relation recognition unit may recognize at least one of subcellular localizations of the two entities, whether or not the two entities are related to the same disease and a pathway, from neighboring context information for the paragraph or sentence.

The relation event may include at least one of a relation between the entities, a source of the entities and location information of the entities.

The relation event generation unit may collect the location information by analyzing a base sequence of each entity.

According to another aspect of the present invention, there is provided a pathway construction method including the steps of: recognizing entities from an input document using an dictionary information database; extracting a context between the recognized entities based on previously stored context pattern information and recognizing a relation between the entities in a method of normalizing the extracted context; generating a relation event of the entities by performing a web search targeting the recognized entities; and creating a pathway by displaying relevant entities at relevant locations in a cell based on the generated relation event.

The pathway construction method may further include the steps of: visualizing the created pathway; and when a specific entity is selected from the visualized pathway, acquiring source information of the specific entity and displaying the source information in a predetermined area of the pathway, and when a line connecting two entities is selected from the visualized pathway, displaying sentences or paragraphs of a document which can explain a relation between two entities.

In addition, the pathway construction method may further include the step of receiving editing information on the visualized pathway from a user and storing the editing information in a pathway database.

The step of generating a relation event of the entities by performing a web search targeting the recognized entities may include the steps of: collecting documents in which the entities appear and information about protein subcellular localizations by performing a web search targeting the entities; and generating a relation event including at least one of a relation between the entities, a source of the entities and information about protein subcellular localizations.

The information about protein subcellular localizations is collected by analyzing a base sequence of each entity.

According to still another aspect of the present invention, there is provided a computer readable recording medium for storing a pathway construction method including the steps of: recognizing entities from an input document using an dictionary information database; extracting a context between the recognized entities based on previously stored context pattern information and recognizing a relation between the entities in a method of normalizing the extracted context; generating a relation event of the entities by performing a web search targeting the recognized entities; and creating a pathway by displaying relevant entities at relevant locations in a cell based on the generated relation event.

### Advantageous Effects

According to the present invention, terminologies expressing a protein, a disease, an enzyme, a medicine, a compound and a symptom can be recognized from a bio-field document, and a pathway can be automatically constructed based on the terminologies.

In addition, manual works needed for constructing a pathway can be minimized by providing bio-field documents for manual verification of the constructed pathway.

### DESCRIPTION OF DRAWINGS

FIG. 1 a view showing a pathway construction system according to the present invention.

FIG. 2 is a flowchart illustrating a pathway construction method according to the present invention.

<Description of Symbols>

| | |
|---|---|
| 100: Pathway construction system | 110: Dictionary information DB |
| 120: Relation information DB | 130: Pathway DB |
| 140: Entity recognition unit | 150: Relation recognition unit |
| 160: Relation event generation unit | 170: Pathway creation unit |
| 180: Visualization unit | 190: Verification unit |

### MODE FOR INVENTION

Details of the objects, technical configurations of the present invention described above and operational effects according thereto will be further clearly understood from the detailed explanation described below with reference to the accompanying drawings of the present invention.

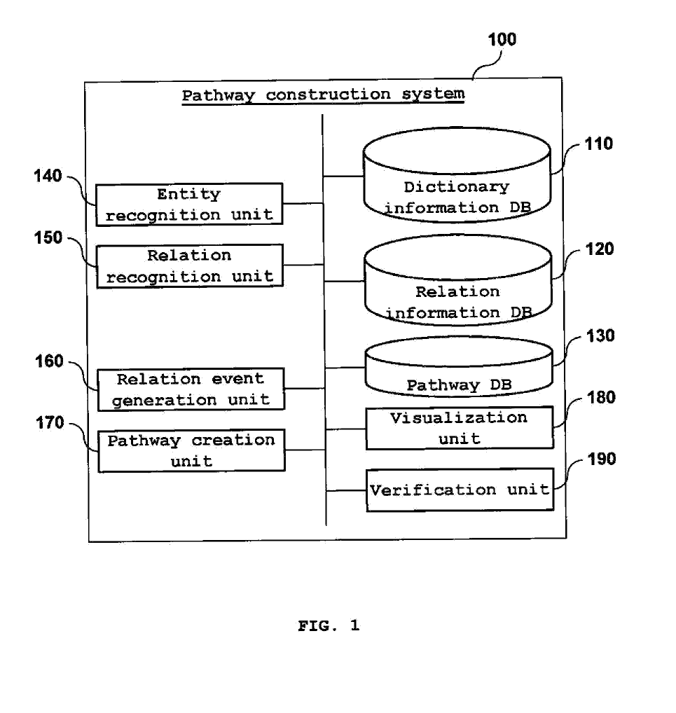

FIG. 1 a view showing a pathway construction system according to the present invention.

Referring to FIG. 1, a pathway construction system 100 includes an dictionary information database 110, a relation information database 120, a pathway database 130, an entity recognition unit 140, a relation recognition unit 150, a relation event generation unit 160, a pathway creation unit 170 and a visualization unit 180.

The dictionary information database 110 stores entity names of a protein, a disease, a compound, a symptom, an enzyme, a medicine, a location, a pathway and the like.

That is, the dictionary information database stores entity names such as a protein name, a disease name, a compound name, a symptom name, an enzyme name and the like.

The entity recognition unit 140 recognizes entities from an input document using the dictionary information database 110. That is, the entity recognition unit 140 recognizes a terminology by performing machine learning-based filtering, which utilizes information collected through a morphological analysis, a syntax analysis and a sematic analysis conducted on the input document as a feature value, and, if the recognized terminology is a terminology registered in the dictionary information database 110, recognizes the terminology as an entity.

The relation recognition unit 150 extracts a context between the recognized entities based on previously stored context pattern information and recognizes a relation between the entities in a method of normalizing the extracted context based on a provided normalization dictionary database.

When two or more entities are recognized by the entity recognition unit 140, the relation recognition unit 150 extracts a context between the recognized entities based on the context pattern information and creates a relation between the entities in a method of normalizing the extracted context based on the normalization dictionary database.

In addition, in the case of a paragraph or a sentence in which two or more entities are recognized, the relation recognition unit 150 recognizes location names of the two entities in a cell from neighboring context information for the paragraph or sentence. In this case, the location names in a cell are stored in the dictionary information database. That is, information on the location of all proteins in a cell and a disease related to the proteins is stored in the dictionary information database. Accordingly, in the case of a paragraph or a sentence in which two or more entities are recognized, the relation recognition unit 150 grasps and groups a case in which two entities (proteins) are related to the same disease and recognizes a relation by utilizing a pattern using the context.

In addition, in the case of a paragraph or a sentence in which two or more entities are recognized, the relation recognition unit 150 may recognize a pathway name from neighboring context information. In this case, the pathway name is stored in the dictionary information database.

Information on the location of all proteins in a cell and a disease related to the proteins is stored in the dictionary information database. In the case of a paragraph or a sentence in which two or more entities are recognized, the relation recognition unit 150 grasps and groups a case in which two entities (proteins) are related to the same disease, recognizes a relation by utilizing a pattern using the context, and visualize the relation considering information on the location in a cell.

In addition, the relation recognition unit 150 may extract event-like verbs expressing an interactive relation such as ‘activate’ or ‘inhibit’ among quite frequently appearing verbs, together with an entity name of a gene or a protein, analyze a pattern, and recognize a relation between entities by utilizing the analyzed pattern information.

For example, from “Our data suggest that lipoxygenase metabolites activate ROI formation which then induce IL-2 expression via NF-kappa B activation.”, relations such as “lipoxygenase metabolites” activates “ROI formation” and “ROI formation” induces “IL-2 expression” are created.

The relation event generation unit 160 collects documents in which the entities recognized by the entity recognition unit 140 appear and information about protein subcellular localizations by performs a web search targeting the entities and generates a relation event including at least one of a relation between the entities, a source of the entities and information about protein subcellular localizations.

That is, the relation event generation unit 160 searches for documents in which the entities appear by searching the entire PubMed targeting the recognized entities. The searched documents may be a source from which a corresponding entity appears. Then, the relation event generation unit 160 collects information about protein subcellular localizations in a sequence-based method.

That is, the relation event includes a relation between the two entities, a disease related to the two entities, and information about protein subcellular localizations. Therefore, the relation event generation unit searches for the location information by analyzing the base sequence of a corresponding entity (protein) in order to acquire information about protein subcellular localizations.

The relation event of the entities generated by the relation event generation unit 160 is stored in the relation information database 120.

The pathway creation unit 170 constructs a pathway by displaying relevant entities at relevant locations in a cell based on the relation event generated by the relation event generation unit 160. At this point, the pathway creation unit 170 converts the generated relation event into a pathway markup language in order to visualize the generated relation event. The markup language for expressing the pathway may include a variety of languages such as SBML, PSI-MI, BioPax and the like.

The pathway created by the pathway creation unit 170 is stored in the pathway database 130.

The visualization unit 180 visualizes the pathway created by the pathway creation unit 170.

In addition, when a specific entity is selected from the visualized pathway, the visualization unit 180 acquires source information of the specific entity from the pathway database 130 and displays the source information in a predetermined area of the pathway.

In addition, if a user selects a line from the pathway, the visualization unit 180 may present sentences or paragraphs of a document which can explain the relation between two entities.

The pathway construction system 100 configured as described above may further include a verification unit 190.

The verification unit 190 allows an expert to confirm the pathway visualized through the visualization unit 180 and stores the information edited using an editing tool in the pathway database 130. That is, the expert may confirm the visualized pathway and, if an error is found in the relation event, correct the error using the editing tool. The editing tool may be, for example, an SBML browser tool.

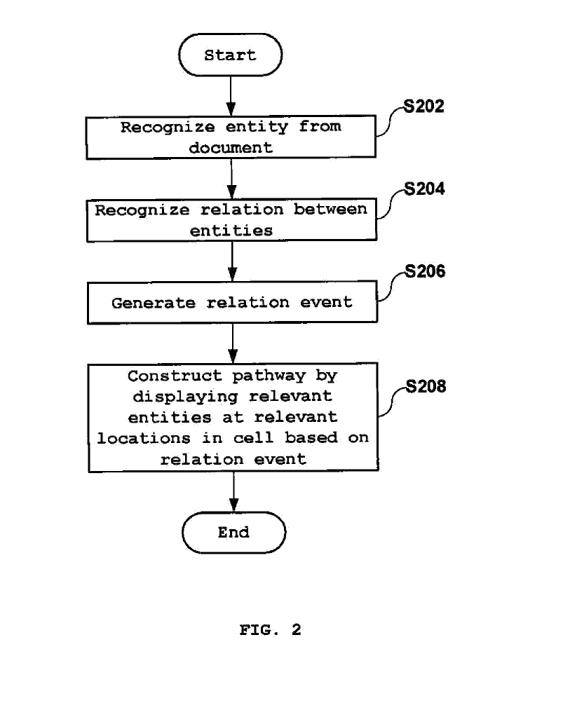

FIG. 2 is a flowchart illustrating a pathway construction method according to the present invention.

Referring to FIG. 2, the pathway construction system analyzes an input document and recognizes an entity (S202). That is, the pathway construction system recognizes a terminology by performing machine learning-based filtering, which utilizes information collected through a morphological analysis, a syntax analysis and a sematic analysis conducted on the input document as a feature value, and, if the recognized terminology is a terminology registered in the dictionary information database, recognizes the terminology as an entity.

After performing step S202, the pathway construction system extracts a context between the recognized entities based on previously stored context pattern information and recognizes a relation between the entities in a method of normalizing the extracted context (S204). At this point, in the case of a paragraph or a sentence in which two or more entities are recognized, the pathway construction system may recognize subcellular localizations of the two entities, whether or not the two entities are related to the same disease, a pathway and the like from neighboring context information for the paragraph or sentence.

After performing step S204, the pathway construction system generates a relation event targeting the recognized entities (S206). That is, the pathway construction system searches for documents in which the entities appear by searching the entire PubMed targeting the recognized entities and collects information about protein subcellular localizations in a sequence-based method. Then, the pathway construction system generates an event including a relation between the two entities, a disease related to the two entities, and information about protein subcellular localizations.

After performing step 3206, the pathway construction system constructs a pathway by displaying relevant entities at relevant locations in a cell based on the relation event (3208). That is, the pathway construction system constructs a pathway by displaying a relevant entity at a location corresponding to the information about protein subcellular localizations of a disease included in the relation event.

If a pathway is constructed as described above, the pathway construction system may visualize the created pathway upon the request of a user. The user may select a specific entity from the visualized pathway and confirm the source of the entity. In addition, the user may select a line connecting two entities and confirm sentences or paragraphs of a document which can explain the relation between the two entities.

The pathway construction method may be created as a program, and codes and code segments configuring the program may be easily inferred by the programmers in the art.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

1. A pathway construction system comprising:
an dictionary information database for storing entity names of at least one of a protein, a disease, a compound, a symptom, an enzyme, a medicine, a location and a pathway;
an entity recognition unit for recognizing entities from an input document using the dictionary information database;
a relation recognition unit for extracting a context between the recognized entities based on previously stored context pattern information and recognizing a relation between the entities in a method of normalizing the extracted context;
a relation event generation unit for collecting documents in which the recognized entities appear and information about protein subcellular localizations by performing a web search targeting the entities, and generating a relation event based on the collected information; and
a pathway creation unit for creating the pathway by displaying relevant entities at relevant locations in the cell based on the recognized relation event.

2. The system according to claim 1, further comprising a visualization unit for visualizing the pathway created by the pathway construction unit.

3. The system according to claim 2, wherein when a specific entity is selected from the visualized pathway, the visualization unit acquires source information of the specific entity and displays the source information in a predetermined area of the pathway, and when a line connecting two entities is selected from the pathway, the visualization unit displays sentences or paragraphs of a document which can explain a relation between the two entities.

4. The system according to claim 2, further comprising a verification unit for receiving editing information on the pathway visualized by the visualization unit from a user and storing the editing information in a pathway database.

5. The system according to claim 1, wherein in the case of a paragraph or a sentence in which two or more entities are recognized, the relation recognition unit recognizes at least one of subcellular localizations of the two entities, whether or not the two entities are related to the same disease and a pathway, from neighboring context information for the paragraph or sentence.

6. The system according to claim 1, wherein the relation event includes at least one of a relation between the entities, a source of the entities and information about protein subcellular localizations.

7. The system according to claim 1, wherein the relation event generation unit collects the information by analyzing a base sequence of each entity.

8. A pathway construction method comprising the steps of:
recognizing entities from an input document using an dictionary information database;
extracting a context between the recognized entities based on previously stored context pattern information and recognizing a relation between the entities in a method of normalizing the extracted context;
generating a relation event of the entities by performing a web search targeting the recognized entities; and
creating a pathway by displaying relevant entities at relevant locations in a cell based on the generated relation event.

9. The method according to claim 8, further comprising the steps of:
visualizing the created pathway; and
when a specific entity is selected from the visualized pathway, acquiring source information of the specific entity and displaying the source information in a predetermined area of the pathway, and when a line connecting two entities is selected from the visualized pathway, displaying sentences or paragraphs of a document which can explain a relation between two entities.

10. The method according to claim 9, further comprising the step of receiving editing information on the visualized pathway from a user and storing the editing information in a pathway database.

11. The method according to claim 8, wherein the step of generating a relation event of the entities by performing a web search targeting the recognized entities includes the steps of:
collecting documents in which the entities appear and information about protein subcellular localizations by performing a web search targeting the entities; and
generating a relation event including at least one of a relation between the entities, a source of the entities and information about protein subcellular localizations.

12. The method according to claim 11, wherein the information about protein subcellular localizations is collected by analyzing a base sequence of each entity.

13. A computer readable medium for storing a pathway construction method comprising the steps of:
recognizing entities from an input document using an dictionary information database;
extracting a context between the recognized entities based on previously stored context pattern information and recognizing a relation between the entities in a method of normalizing the extracted context;
generating a relation event of the entities by Performing a web search targeting the recognized entities; and
creating a pathway by displaying relevant entities at relevant locations in a cell based on the generated relation event.
